(19) United States
(12) Patent Application Publication
(10) Pub. No.: US 2002/0032597 A1
(43) Pub. Date: Mar. 14, 2002

(54) System and method for providing request based consumer information

(76) Inventor: George J. Chanos, Henderson, NV (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/825,772

(22) Filed: Apr. 4, 2001

Related U.S. Application Data
(60) Provisional application No. 60/194,530, filed on Apr. 4, 2000.
(60) Provisional application No. 60/252,446, filed on Nov. 21, 2000.
(60) Provisional application No. 60/251,309, filed on Dec. 4, 2000.
(60) Provisional application No. 60/261,328, filed on Jan. 12, 2001.

(51) Int. Cl. G06F 17/60

(52) U.S. Cl. 705/10

(57) ABSTRACT

The invention includes a system and method for effectively targeting consumer information about various products or services, to those consumers who want to use the product or services. The invention also includes a system and method for matching vendors to those consumers who want information about specific products or services sold, offered, or otherwise made available by the particular vendors. According to one aspect, the invention comprises a request based marketing system (“marketing system”). The marketing system organizes consumer information for a particular product or service into a number of request services, such as, for example, “Discounts,” “Comparisons,” “New Releases,” “Catalogs,” or the like. Because the consumer may subscribe to a particular set of request services corresponding to particular products or services, the marketing system advantageously provides highly customized consumer information to those consumers who actually want to receive it.

### REFERENCE TO RELATED APPLICATION

The present application claims priority benefit under 35 U.S.C. §119(e) from U.S. Provisional Application No. 60/194,530, filed Apr. 4, 2000, entitled “SYSTEM AND METHOD FOR PROVIDING SELECTIVE AUTHORIZATION FOR THE DISSEMINATION OF INFORMATION;” U.S. Provisional Application No. 60/252,446, filed Nov. 21, 2000, entitled “SYSTEM AND METHOD FOR ORGANIZING AND ACCESSING CONSUMER INFORMATION THROUGH BARCODES;” U.S. Provisional Application No. 60/251,309, filed Dec. 4, 2000, entitled “METHOD OF MARKETING COMPUTING DEVICES THROUGH DISSEMINATION OF BUSINESS AND PROMOTIONAL MATERIALS HAVING SCANNABLE INDICIA;” and U.S. Provisional Application No. 60/261,328, filed Jan. 12, 2001, entitled “SYSTEM AND METHOD OF DELIVERING INTERACTIVE ADVERTISEMENTS IN THE FORM OF BANNER ADVERTISEMENTS,” which are incorporated herein by reference.

### BACKGROUND OF THE INVENTION

1. Field of the Invention

The present invention relates generally to online marketing systems, and more specifically, to a system and method for organizing, accessing and delivering consumer information specifically requested by a consumer.

2. Description of the Related Art

As the popularity of the Internet and the World Wide Web has increased over the years, more and more companies are seeking effective advertising solutions in order to promote their products to consumers. One such advertising solution includes the pushing of advertisements to consumers through banners or email. Banner advertisements often include various types of multimedia information, including simple images, which promote products, services, websites, or the like. Although banner advertisements are presented in a wide number of shapes and sizes, they are often shaped similar to a rectangular “banner” anchored to a section of a particular website. When a consumer visits the website, the banner advertisement is pushed to the consumer along with the other information associated with the site. Examples of banner advertisements appear on virtually every commercial Web site on the Internet.

On the other hand, email advertisements include various types of multimedia information formatted into an email message. The consumer's email address is often gathered through a wide number of methods, not all of which are known to, or approved by the consumer. The email address is attached to the email advertisement, and the email is delivered to the consumer. Examples of unsolicited email advertising campaigns are often referred to as online junk mail, or simply spam.

Because of the ineffectiveness of pushing random information to consumers through banner or email advertisements, online advertisers have applied related concepts of matching, tracking, and predicting, to the information found in these delivery mechanisms. For example, online advertisers may attempt to profile types of consumers who visit a particular website. The profile may be based on the online content of the website, self-reported demographic information of a consumer, or consumer tracking. Self-reported demographic information may include areas of interest, income, occupation, age, race, sex, marital status, or the like. Consumer tracking may include recording information about consumer purchases, preferences, or activities, and sending the information back to the online advertising company. Consumer tracking is often accomplished through the use of small files, or cookies, typically stored on a consumer's computer that retain information about the consumer's purchases, preferences, activities, or the like.

Once the online advertisers create the foregoing consumer profiles, they use the profiles to predict or match which products or services the advertisers believe might be interesting to the consumers. Advertisement information associated with the matched products or services is then pushed to the consumer through the foregoing delivery vehicles of banner or email advertisements.

Another solution by online advertisers attempting to overcome the ineffectiveness of pushing random information to consumers, is the use of opt in email. Generally, opt-in email allows a consumer to agree to receive email advertisements based on a broad authorization of a topic or category of information. The online advertiser then determines which information to push to the consumer based on the topic or category. For example, a consumer may authorize an advertiser to send email relating to sales or closeouts. In response, the advertiser may push, via email, closeout pricing information for any item the advertiser selects, based on, for example, the foregoing matching, tracking, or predicting solutions.

Unfortunately the foregoing advertising solutions include a number of drawbacks for consumers and online advertisers. For example, the foregoing solutions often result in an unwelcome and unnecessary invasion of privacy for consumers who provide personal demographic information to online advertisers or whose activities are tracked by the same. Additionally, the foregoing solutions cause consumers to assume some risk associated with non-encrypted electronic transmissions of personal information, as well as the potential for the advertiser to transfer or sell gathered information without the consent of the consumer. For example, although many online companies adopt privacy policies purporting to restrict the use of private information gathered through the foregoing tracking, self-reporting, or the like, some of these companies abruptly change their policy due to, for example, the perceived market value of the forgoing personal information. Thus, through use of the foregoing solutions, the consumer often assumes the risk that the company will sell or otherwise provide the consumer's personal information to others, often without consumer consent or even consumer knowledge of the same.

In addition to the foregoing drawbacks, consumers using the foregoing advertising solutions are often peppered with unwanted information contained in inappropriate banner ads, continuous pop-up windows or unsolicited email. Such unwanted information wastes consumer time and may unwittingly anger otherwise interested customers.

The foregoing advertising solutions also include a number of disadvantages for the advertisers. For example, online advertisers may find that unsolicited banner or email advertisements are costly to produce and disseminate, and are generally ineffective because the vast majority of consumers have little or no interest in the products or services contained therein. In addition, as disclosed in the foregoing, consumers may build a negative perception of a particular company or for commercial email campaigns generally, based on, for example, unsolicited or ineffective email campaigns. Moreover, advertisers who experience poor results from often expensive advertising campaigns may be less inclined to participate in any online advertising.

### SUMMARY OF THE INVENTION

Therefore, a need in the industry exists for an effective way to target online consumer information to consumers who actually want to use the product or services offered therein. Accordingly, one aspect of the invention includes a system and method for effectively targeting consumer information to consumers who want to use various product or services. Moreover, another aspect of the invention includes a system and method for matching vendors to those consumers who want information about specific products or services sold, offered, or otherwise made available by the vendor.

According to one embodiment, the invention includes a request based marketing system for providing request based consumer information to consumer computing devices through a communications network, such as the Internet. The request based marketing system includes one or more portal servers accessing a consumer information database, a subscription database, and a product information database.

Therefore, one aspect of a preferred embodiment of the invention includes a request based delivery system for delivering to a consumer, specific consumer information authorized by the consumer and related to one or more products or services in which the consumer is interested. The delivery system comprises one or more databases which store product information related to one or more products, a communications network, a consumer computing device which allows a consumer to connect to the communications network, and one or more servers communicating with the one or more databases and the communications network. The one or more servers provide electronic documents over the communications network to the consumer computing device. Moreover, at least one server includes a filtering module which allows the consumer to filter the product information stored in the databases and select one or more of the products. The server includes a subscription module which allows the consumer to subscribe to one or more request services for each of the selected one or more products. The server also includes a formatting module which, after receiving consumer information from one or more vendors of the selected one or more products, generates one or more deliverables having portions of the consumer information corresponding to the one or more request services subscribed to by the consumer.

Another aspect of a preferred embodiment of the invention includes a method of providing request-based consumer information to a consumer. The method comprises receiving a selection of one of the one or more filtering mechanisms designed to filter information into organized product listings and providing a consumer with the organized product listings corresponding to the selection. The method also comprises receiving a subscription from the consumer to one or more request services corresponding to one or more products listed in the organized product listings. The subscription authorizes the delivery of consumer information corresponding to the one or more request services. The method includes delivering the consumer information to the consumer.

Another aspect of a preferred embodiment of the invention includes a request based marketing system for allowing a consumer to specifically authorize consumer information to be delivered from time to time to the consumer. The marketing system comprises one or more databases which store consumer information organized into one or more request services. The consumer information comprises information related to one or more products. The marketing system also comprises one or more servers which format and deliver to a consumer, a deliverable having portions of the consumer information related to at least one request service of the one or more request services. In the marketing system, at least one request service is subscribed to by the consumer.

Another aspect of a preferred embodiment of the invention includes a method of providing consumer information about a product to a consumer interested in the product. The method comprises receiving a selection of a product by a consumer and organizing consumer information about the product into specific subject areas. The method also comprises receiving a selection of one or more of the specific subject areas, and formatting a deliverable to be sent to the consumer. The deliverable includes portions of the consumer information corresponding to the selected one or more specific subject areas.

Another aspect of a preferred embodiment of the invention includes a method of organizing online product information from multiple vendors in order for a consumer to efficiently request specific information corresponding to a particular product. The method comprises gathering product listings from multiple vendors and organizing the product listings by brand. The method also comprises providing a consumer with an option to request additional information about at least one product in the product listings marketed under at least one brand.

Another aspect of a preferred embodiment of the invention includes a method of organizing online product information from multiple vendors in order for a consumer to efficiently request specific information corresponding to a particular product. The method comprises gathering product listings from multiple vendors and organizing the product listings by company. The method also comprises providing a consumer with an option to request additional information about at least one product in the product listings marketed by at least one company.

Another aspect of a preferred embodiment of the invention includes a method of organizing online product information from multiple vendors in order for a consumer to efficiently request specific information corresponding to a particular product. The method comprises gathering product listings from multiple vendors and organizing the product listings by product. The method also comprises providing a consumer with an option to request additional information about at least one product in the product listings.

Another aspect of a preferred embodiment of the invention includes a method of placing advertisement information for one or more products with consumers directly interested in the one or more products. The method comprises providing advertisement information for a product to an online company, the advertisement information including a listing of the product and consumer information about the product. Moreover, the online company obtains subscribers to one or more request services and delivers that portion of the consumer information to the subscriber corresponding to the one or more request services to which the subscriber subscribed.

Another aspect of a preferred embodiment of the invention includes a method of obtaining information about a product. The method comprises accessing an online service and selecting a product from product listings of the online service. The method also comprises subscribing to one or more subject areas of consumer information about the selected product, and designating delivery parameters corresponding to the subscription. The delivery parameters govern when the consumer information corresponding to the subscribed-to subject areas will be delivered. The method also comprises receiving the consumer information corresponding to the subscription.

For purposes of summarizing the invention, certain aspects, advantages and novel features of the invention have been described herein. Of course, it is to be understood that not necessarily all such aspects, advantages or features will be embodied in any particular embodiment of the invention.

### BRIEF DESCRIPTION OF THE DRAWINGS

The present invention is described in more detail below in connection with the attached drawings, which are meant to illustrate and not limit the invention, and in which:

FIG. 1 illustrates an exemplary block diagram of an interactive consumer information delivery system, according to aspects of an embodiment of the invention;

FIG. 2 illustrates a flow chart of delivery process, according to aspects of an embodiment of the invention;

FIG. 3 illustrates an exemplary block diagram of a portal server system of the delivery system of FIG. 1, according to aspects of an embodiment of the invention;

FIG. 4 illustrates a filtering process executed by a filtering module of the portal server system of FIG. 3, according to aspects of an embodiment of the invention;

FIG. 5A illustrates a subscription process executed by a subscription module the portal server system of FIG. 3, according to aspects of an embodiment of the invention;

FIG. 5B illustrates an exemplary block diagram of hierarchically organized request services, according to aspects of an embodiment of the invention;

FIG. 6 illustrates a formatting process executed by a formatting module of the portal server system of FIG. 3, according to aspects of an embodiment of the invention; and

FIG. 7 illustrates a population process executed by a database population module of the portal server system of FIG. 3, according to aspects of an embodiment of the invention.

### DETAILED DESCRIPTION OF THE PREFERRED EMBODIMENT

According to one aspect, the invention comprises an interactive consumer information delivery system (“delivery system”) including a request based marketing system (“marketing system”). According to one embodiment, the marketing system provides a wide variety of consumer information to a consumer who has requested or authorized delivery of the consumer information for specific products or services. According to another embodiment, the marketing system organizes the consumer information for a particular product or service into a number of request services, such as, for example, “Discounts,” “Comparisons,” “New Releases,” “Catalogs,” or the like. Because the consumer may subscribe to a particular set of request services corresponding to particular products or services, the marketing system advantageously provides highly customized consumer information to those consumers who actually want to receive it.

According to yet another embodiment, the marketing system provides a potential or actual advertiser with an effective online marketing solution. For example, according to one embodiment, the advertiser submits specific product or service information, along with consumer information related to each product or service. The marketing system advantageously organizes the consumer information into one or more request services, and supplies the consumer information to those consumers who have subscribed to the one or more request services. Alternatively, the marketing system may advantageously gather product or service information, along with consumer information related to the same, and contact a potential advertiser as consumers subscribe to the foregoing consumer information. By allowing the consumer to authorize or subscribe to various request services for a particular product or service, the marketing system advantageously matches advertisers to those consumers most interested in the advertisers' products or services.

To facilitate a complete understanding of the invention, the remainder of the detailed description describes aspects and embodiments of the invention with reference to the figures, wherein like elements are referenced with like numerals throughout.

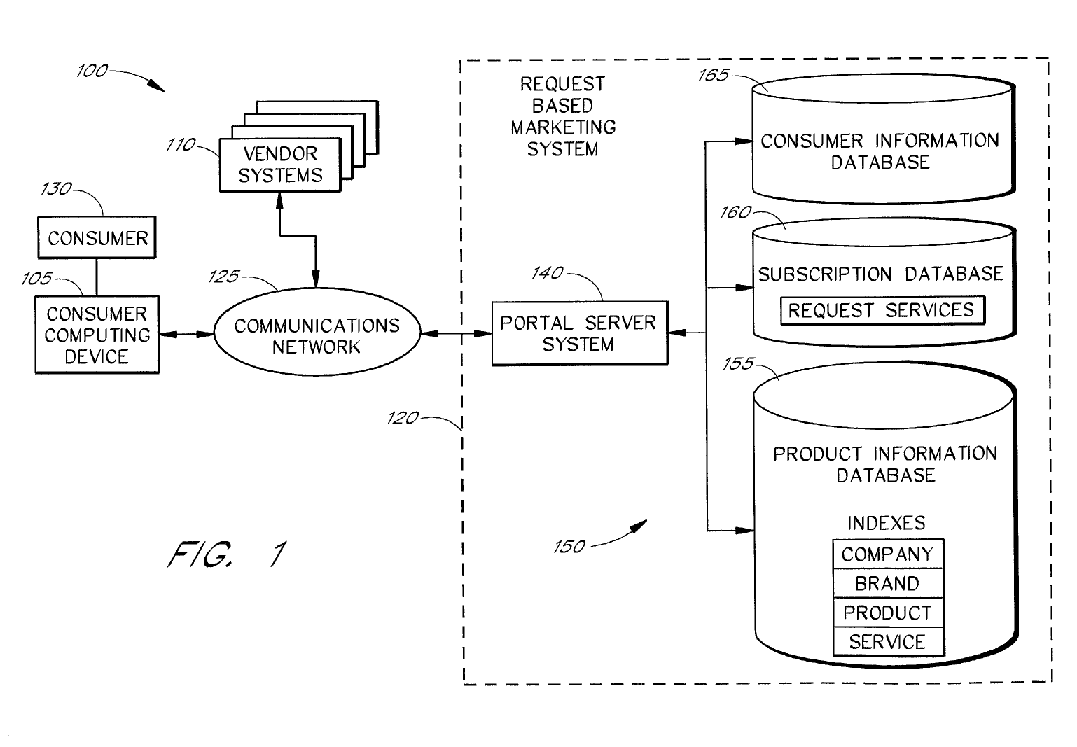

FIG. 1 illustrates an exemplary block diagram of an interactive consumer information delivery system (“delivery system”) 100, according to aspects of an embodiment of the invention. As shown in FIG. 1, the delivery system 100 comprises a consumer computing device 105, one or more vendor systems 110, and a request based marketing system (“marketing system”) 120, communicating with one another through a communications network 125.

According to one embodiment, the delivery system 100 provides a consumer 130 with a variety of consumer information corresponding to one or more products or services (“products”) offered by a virtually limitless number and type of manufactures, suppliers, resellers, retailers, etailers, distributors, wholesalers, service providers, professionals, or the like (“vendors”). For example, according to one embodiment, a particular vendor may register one or more of his or her products with the marketing system 120. In addition, the vendor may supply a wide variety of consumer information for each of the listed products, such as, for example, information regarding discounts, comparisons with other products, new releases of the product, catalogs, or the like. The marketing system 120 advantageously associates or organizes the supplied consumer information into corresponding request services, such as, for example, “Discounts,” “Comparisons,” “New Releases,” “Catalogs,” or the like. Now, when the consumer 130 determines he or she is interested in one or more of the listed products, the marketing system 120 allows the consumer 130 to subscribe to one or more request services associated with the product. The marketing system 120 then advantageously formats a deliverable having the consumer information corresponding to the one or more subscribed-to request services, and delivers the deliverable to the consumer 130.

Based on the foregoing, the delivery system 100 delivers that portion of the consumer information corresponding to the consumer designated product. Therefore, the delivery system 100 advantageously targets consumer information about a particular product, to those consumers who actually want to use, or are otherwise interested in, that product. Thus, the consumer 130 advantageously avoids the aggravation of receiving unwanted solicitations, while the vendor, or advertiser, advantageously avoids wasting resources sending random information to consumers not necessarily interested therein.

According to another embodiment, the marketing system 120 may advantageously gather the foregoing information about vendor products and the consumer information corresponding thereto, from a wide number of online sources, such as, for example, the one or more vendor systems 110. For example, the marketing system 120 may use software programs, often called Internet bots or spiders, to recognize and read information available on the World Wide Web, and send product information as well as consumer information to the marketing system 120. Then, according to one embodiment, when the consumer 130 subscribes to one or more request services corresponding to the gathered product information, the marketing system 120 may advantageously contact a vendor, provide data pertaining to, for example, the number of consumers requesting a particular type of consumer information related to the vendor's product, and thereby form partnering or other arrangements for providing consumer information related to that vendor's products. Thus, the marketing system 120 advantageously recruits advertisers to employ the delivery system 100 to perform their online advertising campaigns. Moreover, the marketing system 120 advantageously provides specific feedback regarding the type of consumer information desired by the consumer 130.

According to yet another embodiment, the marketing system 120 provides the consumer 130 with the ability to filter and organize product information. For example, according to one embodiment, the marketing system 120 allows the consumer 130 to organize product information by one or more search constraints, such as, for example, “Companies,” “Brands,” “Products,” “Services,” or the like. For example, the consumer 130 may advantageously desire consumer information, such as discounts, about his or her favorite brand. By selecting the search constraint “Brand,” the consumer 130 may view product information by, for example, thousands of popular brands, such as, “Delta Airlines” “Guess?,” “Marriott,” “Maytag,” “Pizza Hut,” “Sony,” “Trek,” or the like. According to one embodiment, the marketing system 120 may advantageously further filter product information into one or more topics having one or more subtopics. For example, the brand “Guess?” may advantageously include the topics of, for example, “Clothing,” “Glasses,” “Shoes,” “Watches,” or the like. Moreover, the particular topic “Clothing,” may include the subtopics of, for example, “Logo Tee-Shirts,” “Short Sleeve Shirts,” “Long Sleeve Shirts,” “Sweaters,” “Sweatshirts,” “Jeans,” “Shorts,” or the like. Thus, the marketing system 120 advantageously allows the consumer 130 to efficiently and effectively filter product information to those specific products he or she is most interested in.

As disclosed in the foregoing, the marketing system 120 also allows the consumer 130 to organize product information by the search constraint of, for example, “Products.” Although “Products” may include topics and subtopics of products, similar to “Brands,” the “Products,” constraint may include some portion of the North American Industry Classification System (NAICS) categories. For example, the marketing system 120 may organize the product information into topics of, for example, “Electronics,” “Kitchenware,” “Music,” “Sporting Goods,” or the like. “Services” may advantageously include professional designations, such as, for example, “Dentists,” “Doctors,” “Electricians,” “Mechanics,” or the like.

Although the marketing system 120 may organize and filter product information as disclosed in foregoing, a skilled artisan will recognize from the disclosure herein that a large number of search constraints subdivided into a large number of topics and subtopics may advantageously assist the consumer 130 in efficiently and effectively finding products he or she desires.

FIG. 1 also shows the delivery system 100 including the consumer computing device 105. According to one embodiment, the consumer computing device 105 may advantageously comprise virtually any device capable of interacting with the communications network 125 so as to receive and send electronic information thereto. Moreover, according to one embodiment, the consumer computing device 105 includes at least one input mechanism, such as, for example, a pointer, a keypad or keyboard, touch screen, or the like, allowing the consumer 130 to interact with the consumer computing device 105. According to one exemplary embodiment, the consumer computing device 105 comprises a processor, memory, the foregoing input-output mechanism, an operating system, and a communications protocol, such as, for example, a TCP/IP stack, for establishing communication with the communications network 125.

Although the consumer computing device 105 is disclosed with reference to the foregoing embodiments, the system is not intended to be limited thereby. Rather, a skilled artisan will recognize from the disclosure herein a wide number of alternative embodiments of the consumer computing device 105. For example, the consumer computing device 105 may individually, or in various combinations, comprise a personal computer, computer system or work station, an interactive television, an interactive kiosk, a personal mobile computing device, a digital assistant, a mobile phone, a laptop, or the like. In such alternative systems, the operating systems will likely differ and be adapted for the particular computing device. However, according to one embodiment, the operating system advantageously continues to provide the appropriate communications protocols needed to establish communication between the consumer computing device 105 and the communications network 125.

FIG. 1 also illustrates the delivery system 100 including the one or more vendor systems 110. According to one embodiment, the vendor systems 110 comprise virtually any computing device capable of connecting the vendor to the marketing system 120 through the communications network 125. For example, the vendor system 110 may advantageously include any individual or combination of the devices disclosed with reference to the consumer computing device 105. Moreover, the vendor system 110 may advantageously include a website accessible through, for example, the Internet, and designed to produce information about a particular vendor's products.

FIG. 1 also illustrates the delivery system 100 including the communications network 125. According to one embodiment, the communications network 125 comprises the Internet. The structure of the Internet, which is known to those of ordinary skill in the art, includes a network backbone with networks branching from the backbone. However, one of ordinary skill in the art will recognize from the disclosure herein that the communications network may comprise individually or in various combinations, a private, local, or wide area network, one or more wireless, optical, or satellite connections, telephone or communication networks, or the like. Moreover, the consumer computing device 105, the one or more vendor systems 110, and the marketing system 120, may individually or in combination connect to the communications network 125 through conventional Internet service providers, such as, for example, dial-up modem connections, digital subscriber lines, cable modems, fiber connections, dedicated servers, wireless systems or the like.

FIG. 1 also illustrates the delivery system 100 including the marketing system 120. According to one embodiment and as shown in FIG. 1, the marketing system 120 comprises a portal server system 140 connected to one or more databases 150. According to one embodiment, the one or more databases 150 may advantageously include a product information database 155, a subscription database 160, and a consumer information database 165.

According to one embodiment, the portal server system 120 comprises one or more servers communicating with the one or more databases 150 and the communications network 125. According to one embodiment, the portal server system 120 may advantageously serve electronic documents, run back-end applications, manage communication with the one or more databases 150, or the like.

The marketing system 120 also includes the product information database 155. According to one embodiment, the product information database 155 stores product information relating to the products from one or more vendors. The product information may advantageously include a wide number of listings for a wide number of companies, products, brands, services, or the like. Moreover, according to one embodiment, the product information may advantageously include some information corresponding to the product, such as, for example, product specifications, marketing information, or the like.

According to one embodiment, the product information database 155 also includes one or more indexes, such as, for example, indexes on companies, brands, products, services or the like. The indexes advantageously provide quick access to pre-organized product information. Thus, according to one embodiment, the portal server system 140 may access the product information stored in the product information database 155, and thereby receive data organized by, for example, a particular company, a particular brand, a particular product, a particular service, or the like.

As disclosed in the foregoing, the marketing system 120 also includes the subscription database 160. According to one embodiment, the subscription database 160 stores information relating a particular consumer to one or more request services. The request services advantageously comprise subject areas or categories, and sub-subject areas or subcategories of consumer information for, for example, each product listed in the product information database 155. The consumer 130 may advantageously subscribe to one or more of the foregoing subject areas for a particular product, and receive the consumer information corresponding thereto. For example, a request service may comprise discounts, such as sales, coupons, and rebates, or comparisons, such as prices, policies, or opinions, or new releases, such as, planned releases or future prototypes, or information, such as news, locations, and support. Moreover, the request services may include consumer information for a particular product available through catalogs, or for the obtaining of catalogs, or special offers such as offers for participation in surveys, offers for participation in focus groups, or samples made available for providing feedback. Thus, as the consumer 130 reviews products the marketing system 120 produces from the product information database 155, the consumer 130 may desire to subscribe to one or more request services corresponding to a particular product. For example, the consumer may subscribe to planned new releases for a particular brand of a particular product.

Although the request services are disclosed with reference to its preferred embodiments, the disclosure is not intended to be limited thereby. Rather, a skilled artisan will recognize from the disclosure herein a wide number of alternatives subject areas and sub-subject areas for organizing the consumer information.

FIG. 1 also shows the marketing system 120 having the consumer information database 165. As disclosed in the foregoing, the consumer information database 165 stores consumer information. Consumer information may advantageously include a wide number of varying information generally related to particular products. For example, consumer information may include virtually any information relevant to a particular product, such as, for example, news, commentary, testimonials, references, specifications, features, advantages, marketing materials, opinions, reviews, surveys, focus group results or studies, industry reports or comparisons, sales, coupons, specials, product retail locations, maps, technical support, help links, customer service, activation or deactivation, assembly instructions, owners manuals, product or service histories, warrantees, rebates, or the like. According to one embodiment, some or all of the consumer information may include information that changes on a very frequent basis (“dynamic information”), such as, for example, price, sale campaigns, new release information, warrantees, rebates, or any of the types of information disclosed in foregoing with reference to the static consumer information. According to this embodiment, the marketing system 120 may advantageously update the dynamic information periodically, at consumer-specified intervals, some or each time the consumer information is accessed, from time to time, or the like.

According to one embodiment, the foregoing consumer information is organized to correspond to one or more of the request services. Thus, when the portal server system 140 determines that the consumer 130 has subscribed to a particular request service, the portal server system 140 may advantageously access the consumer information database 165 and deliver the consumer information corresponding to the particular subscribed-to request service.

Thus, according to the foregoing embodiments, the marketing system 120 advantageously stores product information from one or more vendors in the product information database 155, where the product information is organized by one or more of a variety of indexes. Moreover, the marketing system 120 advantageously stores in the consumer information database 165, consumer information corresponding to each of the products stored in the product information database 155 and advantageously organizes the consumer information into one or more of the request services. In addition, the marketing system 120 tracks consumer subscriptions to the one or more request services, and delivers the appropriate subscribed-to, or authorized consumer information to the consumers requesting the same.

Although the one or more database 150 are disclosed with reference to their preferred embodiments, the disclosure is not intended to be limited thereby. Rather, a skilled artisan will recognize from the disclosure herein a wide number of alternative storage solutions for the product information, the consumer information, or the information relating particular consumers to their subscribed-to request services. For example, the information may be stored in a single database, multiple databases in the same or geographically remote locations, multiple databases using data mirrors, partial data mirrors, or the like, or different physical or logical organizations of the foregoing information.

In addition to the foregoing, one embodiment of the marketing system 120 advantageously avoids placing consumers in the position of having to assume the risk of unwanted disclosure or sale of personal information. According to one embodiment where consumer information is emailed to the consumer 130, the marketing system 120 collects the consumer' email address, a name by which the consumer wishes to be written to, and the various request services for products, to which the consumer subscribes. Moreover, according to one embodiment, when the consumer 130 desires to make an online purchase of one or more products, the marketing system 120 places the consumer 130 in contact with the appropriate vendor or vendor system 110, thereby avoiding the collection of any personal or otherwise private information. Thus, the consumer 130 can be assured that the entity controlling the marketing system 120 will not misuse private information, because, according to one embodiment, the marketing system 120 does not request or otherwise store such information.

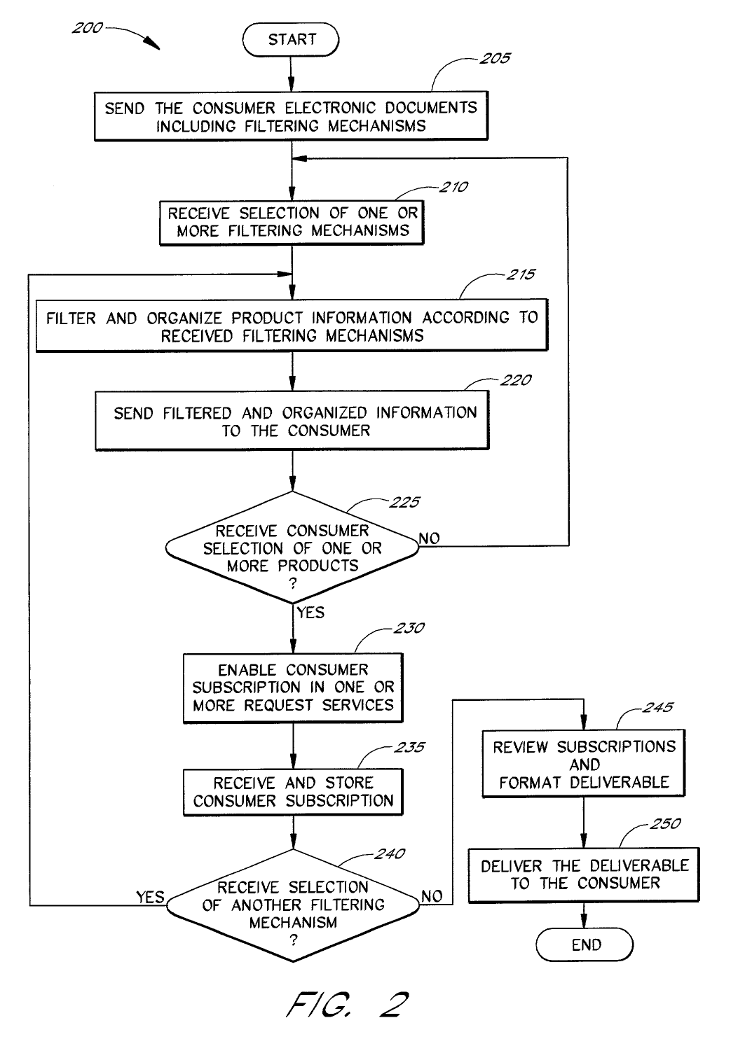

FIG. 2 illustrates a flow chart of a delivery process 200 for delivery of request based consumer information, according to an embodiment of the system. As shown in FIG. 2, the delivery process 200 begins with Block 205 where the marketing system 120 sends the consumer 130 one or more electronic documents having one or more filtering mechanisms. According to one embodiment, the one or more filtering mechanisms allow the consumer 130 to specify how the marketing system 120 will organize and filter the product information to be sent to the consumer 130, thereby allowing the consumer 130 to quickly and efficiently find specific products, about which they wish to receive consumer information. According to one embodiment, the filtering mechanism may include the ability to browse topically and subtopically organized product information, brand or company organized product information, product or service organized product information, or the like. According to another embodiment, the filtering mechanism may include searching, such as, for example, entering search criteria into natural language or binary search engines, and receiving result or hit lists.

According to yet another embodiment of the system, the filtering mechanism may include developing search constraints, such as, for example, selectable pull down menus or check boxes for instructing the marketing system 120 how the information is to be organized for the consumer 130. For example, according to one embodiment, the consumer 130 may advantageously choose a first level search constraint from a pull down menu or checkbox, which produces a set of second level search constraints on a pull down menu, each of which may produce a set of third level search constraints, and so on. For example, the consumer 130 may select from the search constraints of, for example, “Companies,” “Brands,” “Products,” “Services,” or the like. Moreover, the consumer 130 may then choose a second level search constraint from a pull down menu or checkbox of, for example, a first letter of, for example, the selected company, selected brand, selected product, selected service, or the like. The consumer 130 may then advantageously choose a third level search constraint from a pull down menu or checkbox of, for example, a particular company, brand, product, service, or the like. For example, the consumer 130 may select the search constraint “Company,” the search constraint “A,” the search constraint “Apple,” and the search constraint “Power Macs,” thereby filtering the product information into that information listing types of Power Macs available from Apple Computer, Inc.

After the consumer chooses from the foregoing one or more filtering mechanisms, the delivery process 200 continues to Block 210, where the marketing system 120 receives the consumer selection of the one or more filtering mechanisms. The delivery process 200 continues to Block 215 where the marketing system 120 filters and organizes the product information according to the received filtering mechanisms. The delivery process 200 then continues to Block 220 where marketing system 120 sends the filtered and organized product information to the consumer 130.

The delivery process 200 continues to Decision Block 225 where the marketing system 120 receives the selection of one or more products from the product information sent to the consumer 130. According to one embodiment, when the marketing system 120 does not receive a selection of any of the products from the product information sent to the consumer 130, the delivery process 200 returns to Block 210 and waits to receive a selection of another filtering mechanisms. Thus, the delivery process 200 advantageously allows the consumer 130 to select a particular filtering mechanism, and then browse through the product information by continuing to select other filtering mechanisms until finding one or more products, in which the consumer 130 is interested.

At Decision Block 225, when the marketing system 120 does receive a selection of one or more particular products, the delivery process 200 continues to Block 230 where the marketing system 120 enables consumer subscription to the one or more request services. For example, according to one embodiment, the marketing system 120 may advantageously provide a request service subscription mechanism (“subscription mechanism”) which guides the consumer 130 through subscribing to one or more of the request services for a particular product. For example, the subscription mechanism may advantageously comprise a graphical user interface (GUI), electronic documents containing checkboxes, pull down menus and submenus, applets, scripts, or the like, which guide the user through subscribing to various request services. According to one embodiment, the subscription mechanism may be transmitted to, or may already be residing on, the consumer computing device 105.

According to another embodiment, the marketing system 120 may provide electronic forms or documents, which allow the consumer 130 to select one or more request services. For example, the electronic forms or documents may include one or more check boxes or check box groups for allowing the consumer to specifically subscribe to one or more of the request services.

The delivery process 200 continues to Block 235, where the marketing system 120 receives and stores subscriptions to the one or more request services. According to one embodiment of the system, the marketing system 120 stores the consumer subscriptions in the subscription database 160.

The delivery process 200 then proceeds to Decision Block 240, where the marketing system 120 may receive a selection of another filtering mechanism from the consumer 130. When the marketing system 120 receives such a selection, the delivery process 200 returns to Block 215 where the marketing system 120 filters and organizes the product information from, for example, the product information database. Thus, the delivery process 200 advantageously provides the consumer 1030 with the ability to subscribe to the one or more request services for a particular product, and then proceed to other products using the same or other filtering mechanisms.

On the other hand, when the marketing system 120 does not receive another selection of a filtering mechanism at Decision Block 240, the delivery process 200 continues to Block 245, where the marketing system 120 reviews the information in the subscription database 160 and consumer information database 165, and then formats one or more deliverables. For example, the marketing system 120 may advantageously determine whether changes have occurred to the dynamic consumer information in the consumer information database 165, such as, for example, changes in price, new releases, news, or the like. According to one embodiment, when changes exist, the marketing system 120 may advantageously format a deliverable with the changed consumer information, which, at Block 250, is then sent to the particular consumer.

However, a skilled artisan will recognize from the disclosure herein a wide number of alternatives, outside of a change to the dynamic information, which may advantageously trigger the formatting and delivery of the deliverables. For example, the marketing system 120 may format deliverables at consumer specified intervals, when new consumer information arrives in the consumer information database 165, when the consumer 130 subscribes to particular request services, periodically, from time to time, or the like.

According to one embodiment, the deliverable may advantageously comprise an email, regular mail, a page, a telephone or mobile phone call or message, a message to the consumer computing device, or the like. Moreover, according to one embodiment, the deliverable may advantageously include information allowing the consumer 130 to begin a transaction, be transported to the one or more vendors 110, or subscribe to additional request services. For example, the deliverable may advantageously include commercial transaction commands, such as, hyperlinks, enabling the consumer 130 to order or otherwise purchase the one or more products for which the deliverable was created. According to one embodiment, the commercial transaction may advantageously occur with a vendor on the vendor system 110. According to another embodiment, the marketing system 120 may advantageously act as a broker for the commercial transaction between the vendor and the consumer 130. According to yet another embodiment, the consumer 130 may transact directly with the marketing system 120.

In addition to the foregoing, the deliverable may advantageously include transport commands, such as, for example, hypertext, thereby connecting the consumer computing device 105 with a vendor of the one or more products for which the deliverable was created. According to one embodiment, the deliverable may direct the consumer computing device 105 to the marketing system 120, and the marketing system 120 may serve electronic documents from the vendor system, such as, for example, framed documents from partnering vendors. According to yet another embodiment, the deliverable may provide the consumer 130 with the ability to request addition consumer information, such as, for example, subscribing to additional request services offered by the marketing system 120.

Based on the foregoing, the delivery process 200 advantageously allows a consumer to filter through a potentially large volume of product information, and to subscribe to particular request services corresponding to a particular product, thereby receiving consumer information corresponding to the request service. Thus, the delivery process 200 allows the consumer to specifically authorize advertisers to deliver select information about select products in which he or she has interest, rather than receive less effective random or pseudo-random information from advertisers.

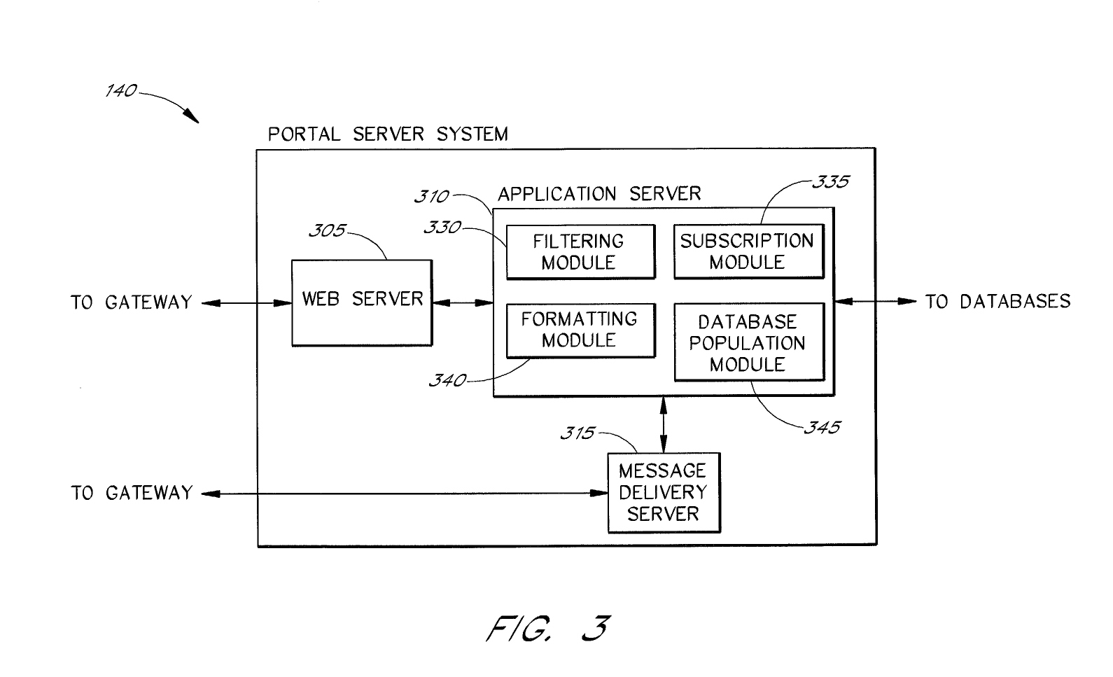

FIG. 3 illustrates an exemplary block diagram of the portal server system 140 of FIG. 1, according to aspects of an embodiment of the system. As shown in FIG. 3, the portal server system 140 comprises a web server 305, an application server 310, and a message delivery server 315. According to one embodiment, the web server 305 comprises one or more conventional web servers, such as, for example, those commercially available from Apache, Linux, Microsoft, or the like. The web server 305 may advantageously serve electronic documents to the consumer computing device 105, including, for example, static or active server pages, or the like. Moreover, the web server 305 may advantageously receive and send information over the communications network 125 in, for example, HTML, XML, or other known Internet data formats. Moreover, the web server 305 may advantageously communicate with the application server 310.

According to one embodiment, the application server 310 comprises one or more conventional application servers, such as, for example, those commercially available from Apache, Linux, Microsoft, or the like. According to one embodiment, the application server 310 includes one or more applications or software modules, providing at least some of the functionality of the marketing system 120, along with translation of requests and commands between, for example, browser based systems to back-end business applications or databases. For example, the application server 310 may include software programs converting information and commands from conventional markup languages, to, for example, standard query languages (SQL). Moreover, the application server 310 communicates with the message delivery server 315 in order to format, for example, deliverables having consumer information.

As disclosed in the foregoing, according to one embodiment, the application server 310 includes software programs or modules, which provide at least some of the functionality of the marketing system 120. According to one embodiment, the software modules of the application server 310 comprise a filtering module 330, a subscription module 335, a formatting module 340, and a database population module 345. According to one embodiment of the system, the filtering module 330 includes software for providing the filtering mechanisms disclosed with reference to FIG. 2. For example, the filtering module may allow the consumer 130 to govern the organization and filtering of the product information through, for example, browsing, searching, application of relational constraints, or the like.

According to one embodiment, the subscription module 335 includes software designed to allow the consumer 130 to subscribe to one or more of the request services. Moreover, the formatting module 340 includes software designed to format one or more types of deliverables having consumer information corresponding to subscribed-to request services. In addition, according to one embodiment, the database population module 345 comprises software designed to populate the one or more database 150 with the product and consumer information.

Although the application server 310 is disclosed with reference to its preferred embodiment, the invention is not intended to be limited thereby. Rather, a skilled artisan will recognize from the disclosure herein a wide number of software modules and business applications that may reside on the application server 310. For example, the application server 310 may advantageously include one or more ecommerce modules, providing functionality for commercial transactions. Moreover, the application server 310 may include mapping modules designed to provide locations and maps corresponding to, for example, various request services. According to one embodiment, the mapping modules may advantageously poll one or more of the vendor systems 110, such as, for example, partnering vendors which provide mapping data, such as, for example, data commercially available from Mapquest.

FIG. 3 also shows the portal server system 140 having the message delivery server 315. According to one embodiment, the message delivery server 315 may advantageously comprise one or more email exchange servers designed to multicast email messages to lists of consumer email addresses, a paging system designed to provide consumer information, such as reminders or the like in the form of pages, or virtually any system capable of delivering specific consumer information to the consumer computing device 105. According to another embodiment, the message delivery server 315 may provide voice mail or other communications to the consumer 130.

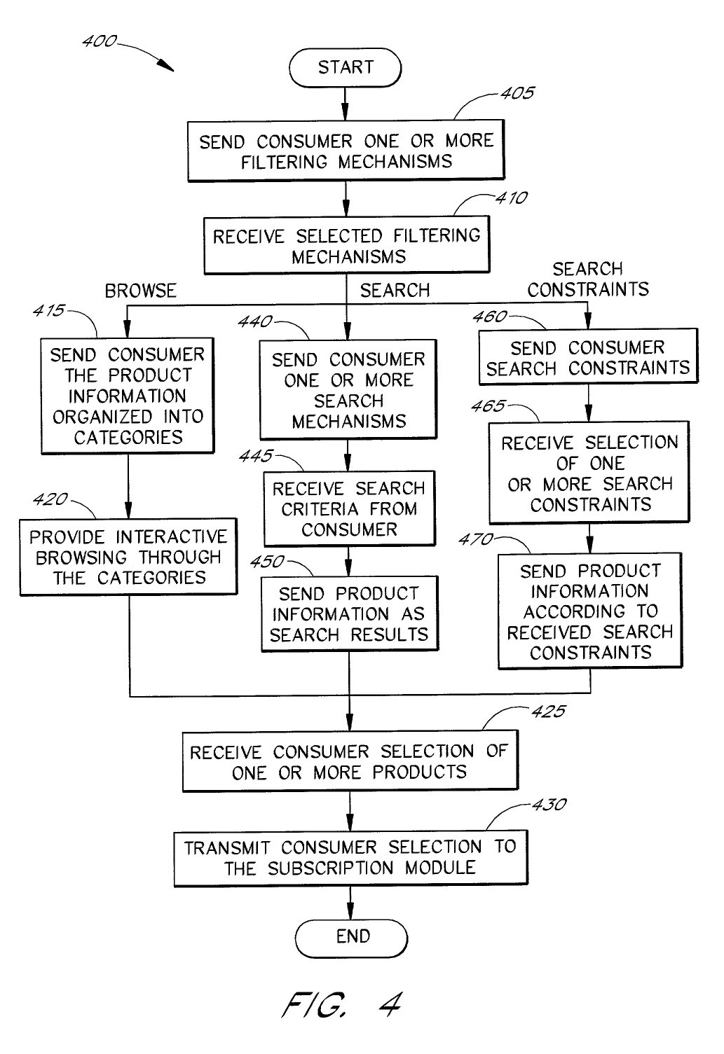

FIG. 4 illustrates a filtering process 400 executed by the filtering module 330, according to aspects of an embodiment of the system. According to one embodiment, the filtering process 400 allows the consumer 130 to govern the organization and filtering of the product information. For example, as shown in FIG. 4, the filtering process 400 begins with Block 405 where the marketing system 120 sends one or more filtering mechanisms to the consumer computing device 105. As disclosed in the foregoing, the filtering mechanisms may advantageously provide the functionality of browsing, searching, or the application of one or more search constraints.

According to one embodiment, when the consumer 130 has determined or selected one or more filtering mechanisms, the selection is received by the filtering module 330 in Block 410. When the filtering mechanism selected by the consumer 130 includes browsing-type functionality, the filtering process 400 proceeds to Block 415 where the filtering module 330 sends the product information from the product information database 155 to the consumer computing device 105. According to this embodiment, the product information is organized into categories, many of which have subcategories and so on, such as, for example, the type of information organization used by many current websites, such as, for example, Yahoo.com.

The filtering process 400 then proceeds to Block 420, where the filtering module 330 interacts with the consumer computing device 105 to provide interactive browsing of the categories and subcategories of product information. According to one embodiment, once the consumer 130 selects one or more particular products from a category or subcategory, the selection is received by the filtering module 330 at Block 425. According to another embodiment, the filtering module 330 then transmits, at Block 430, a message to the subscription module 335, indicating the consumer selection of the one or more particular products.

On the other hand, when the filtering module 330 receives the consumer selected filtering mechanism at Block 410, and the selection includes searching functionality, the filtering process 400 proceeds to Block 440 where the filtering module 330 sends a search mechanism to the consumer 130. As disclosed in the foregoing, the search mechanism may include, for example, binary or other term-combinable text searching mechanisms, natural language search engines, or the like. Once the filtering module 330 receives, at Block 445, one or more search criteria selected by the consumer through the search mechanism, the filtering process 400 proceeds to Block 450 where the filtering module 330 sends the product information as results or hits from the search criteria being applied to the product information. According to one embodiment, when the consumer 130 selects one or more products from the search results, the filtering process 400 proceeds to Block 425 where the filtering module 330 receives the consumer selection.

When the filtering module 330 receives the consumer selected filtering mechanism at Block 410, and the selection includes search constraints, the filtering process 400 proceeds to Block 460 where the filtering module 330 sends one or more search constraints to the consumer computing device 105. According to one embodiment, the filtering module 330 may provide the search constraints in the form of pull down menus or the like. According to one embodiment, after the consumer 130 selects the one or more search constraints found in the, for example, pull down menus, those search constraints are sent to the filtering module 330 at Block 465 of the filtering process 400. Thereafter, the filtering module 330, at Block 470, sends the product information matching the received one or more search constraints. According to one embodiment, when the consumer 130 selects one or more products from the product information organized by the search constraints, the filtering process 400 proceeds to Block 525 where the filtering module 330 receives the consumer selection.

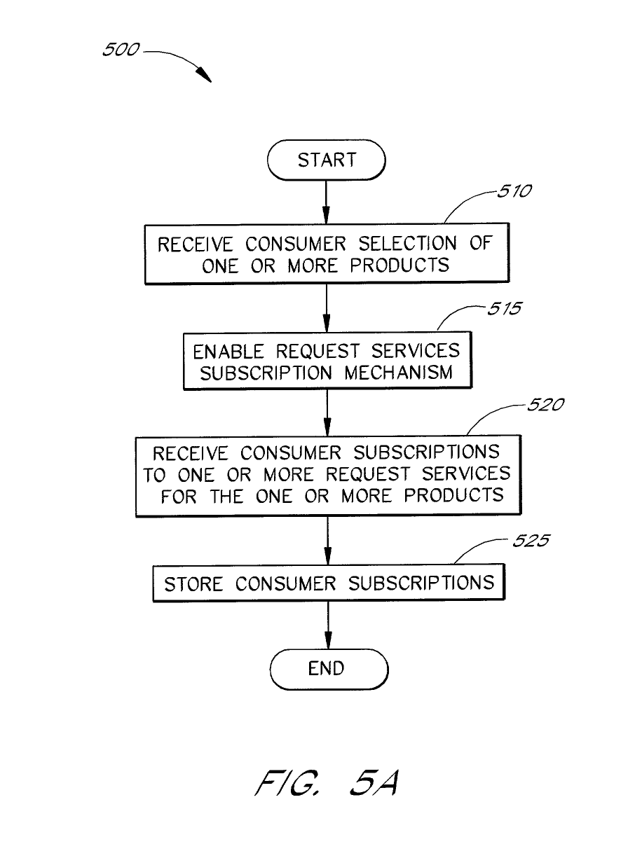

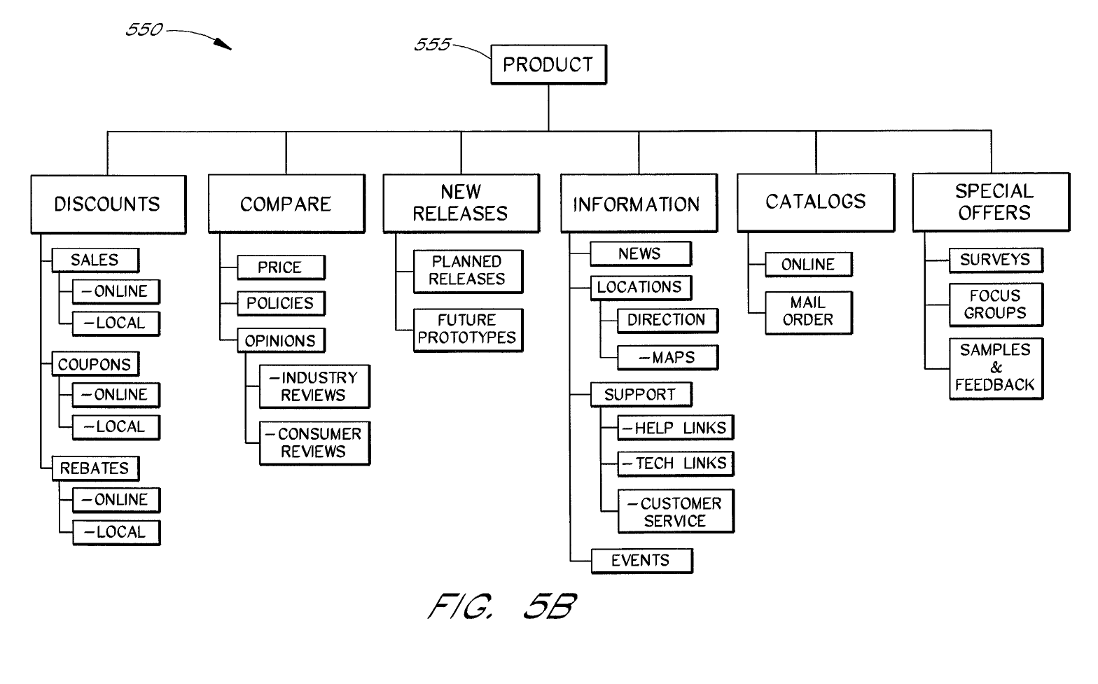

FIG. 5A illustrates a subscription process 500 executed by the subscription module 335 of the application server 310, according to aspects of an embodiment of the system. As shown in FIG. 5A, the subscription process 500 begins in Block 510 when the subscription module 335 receives a consumer selection of one or more products from the product information sent to the consumer by the filtering module 330. According to one embodiment, the subscription process 500 proceeds to Block 515 where the subscription module 335 enables the request services subscription mechanism. As disclosed in the foregoing, the subscription mechanism may advantageously include a scripting or otherwise client-resident software program executing on the consumer computing device 105 to guide the consumer 130 in subscribing to one or more of the request services corresponding to the selected product. Alternatively, as disclosed in the foregoing, the subscription mechanism may advantageously comprise one or more electronic forms or documents having, for example, check boxes, groups of check boxes, pull down menus, or the like, guiding the consumer 130 through the subscription to one or more of the request services.

According to one embodiment, once the consumer 130 interacts with the subscription mechanism to record the consumer's subscriptions, the subscription process 500 continues to Block 520 where the subscription module 335 receives the consumer subscriptions from the subscription mechanism. The subscription process 500 continues to Block 525, where the subscription module 335 stores the consumer subscriptions in, for example, the subscription database 160.

FIG. 5B illustrates an exemplary block diagram of hierarchically organized request services 550, according to aspects of an embodiment of the system. As shown in FIG. 5B, the request services 550 for a particular product 555 may advantageously comprise hierarchically organized subject areas or categories and subcategories relating to the product 555. For example, the request services 550 may be organized into, for example, categories such as “Discounts,” “Comparisons,” “New Releases,” “General Information,” “Catalogs,” “Special Offers,” or the like. Moreover, as shown in FIG. 5B, each of the foregoing categories may further be organized into a wide number of continually more specific areas of interest.

Although the request services 550 are disclosed with reference to their preferred embodiment, the system is not intended to be limited thereby. Rather, a skilled artisan will recognize from the disclosure herein a wide number of alternatives for the request services 550. For example, as shown in FIG. 5B and according to one embodiment, the request services 550 may include various additional consumer-specified parameters. For example, according to one embodiment, the request services 550 include the category of “Events.” Thus, when the consumer 130 selects, for example, movies, live shows, concerts, sports teams, celebrities, musicians, comedians, or the like, as the product 555, the consumer 130 may advantageously subscribe to receive consumer information on, for example, events surrounding a particular one of the forgoing list.

Moreover, according to one embodiment, the consumer 130 may additionally enter parameters, such as, for example, defining time or date windows, venues, or the like, within which the consumer 130 wishes to receive consumer information pertaining to the particular event. For example, the consumer 130 may subscribe to receive show times and locations for, for example, the particular live shows occurring at a specific venue, during weekend evenings, for the next month. Additionally, the consumer 130 may subscribe to request services providing maps, reservation information, or the like. Thus, the request services 550 advantageously allow consumers to specify specific types of consumer information they wish to receive for the specific products they have chosen. Moreover, according to one embodiment, consumers may advantageously further designate parameters, such as, for example, the frequency of delivery, delivery when the consumer information reaches a threshold, such as, for example, a threshold price, a date range, a delivery schedule, an action by a supplier of the consumer information, an action by the consumer, or the like. The parameters advantageously further define the types of consumer information that the marketing system 120 will deliver. Thus, the marketing system 120 allows consumers to authorize with varying degrees of specificity, the type of consumer information they wish to receive for the products they select.

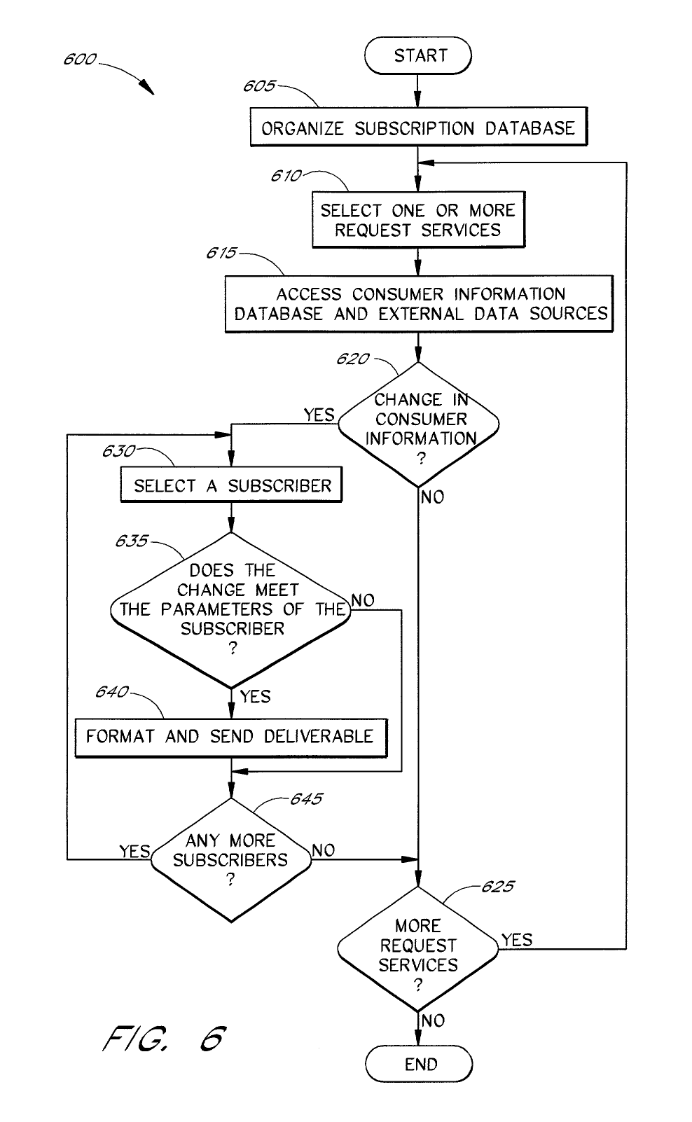

FIG. 6 illustrates a formatting process 600 executed by the formatting module 340 of the application server 310, according to aspects of an embodiment of the system. As shown in FIG. 6, the formatting process 600 begins at Block 605, when the formatting module 340 accesses and organizes the subscription database 160. According to one embodiment, the formatting module 340 may advantageously organize the subscriptions in the subscription database according to, for example, the origin of the consumer data corresponding to each request service. For example, according to one embodiment, the consumer information for a particular product from a particular vendor may include coupons, price, news, opinions, and the like, all organized into their respective request services. Moreover, the marketing system 120 may also recognize that according to this embodiment, the foregoing consumer information is acquired from the vendor system 110 of the particular vendor. Thus, according to one embodiment, the formatting module 340 may advantageously organize the request services such that the marketing system 120 polls the vendor system 110 for updated consumer information a minimum number of times. However, a skilled artisan will recognize from the disclosure herein that the subscriptions in the subscription database 160 may advantageously be organized by a wide number of parameters, including, for example, a particular product, a particular source of the corresponding consumer information, by request service, or the like.

After the subscription database is organized, the formatting process 600 proceeds to Block 610 where the formatting module 340 selects one or more of the request services. As disclosed in the foregoing, the formatting module 340 may group the request services by a particular product, a particular source of the corresponding consumer information, by request service, or the like. For the one or more selected request services, the formatting module 340, at Block 615, accesses the consumer information stored in the consumer information database 165 corresponding to the selected request services. According to one embodiment, the formatting module 340 also accesses any external data sources of that consumer information. For example, the formatting module 340 may request from the one or more vendor systems 110, any updated consumer information corresponding to the request services.

The formatting process 600 then proceeds to Decision Block 620, where the formatting module 340 determines whether the consumer information corresponding to the selected request services has changed. When the consumer information has not changed, the formatting process 600 proceeds to Decision Block 625, where the formatting module 340 determines whether there are any more request services. When there are more request services, the formatting process 600 returns to Block 610 and selects another group of request services. When, at Decision Block 625, there are no more request services, the formatting process 600 ends.

When the formatting module 340, at Decision Block 620, determines that the consumer information has changed, the formatting process 600 proceeds to Block 630, where the formatting module 340 selects a subscriber to the one or more selected request services. The formatting module 340 then, at Decision Block 625, determines whether the changes to the consumer information meet the parameters of the particular subscriber. For example, when the consumer 130 subscribes to the one or more request services, the consumer 130 may advantageously include a wide number of parameters for the consumer information corresponding to each request. For example, the consumer 130 may subscribe to the request service of pricing information, and only want to be notified when the price of the corresponding product is below a certain limit. According to this example, the formatting module 340 at Block 635 advantageously compares the changed consumer information, e.g., the price, and determines whether the new price meets the price parameter of the subscribing consumer. When it does, the formatting module 340 formats a deliverable and delivers it to the consumer 130.

As disclosed in the foregoing, the deliverable may advantageously include virtually any message, such as, for example, a notice, an alarm, a reminder, or the like, to the consumer 130, including an email, a regular mail, a page to, for example, a pager, a personal digital assistant (“PDA”), a telephone or mobile phone, or the like, a telephone or mobile phone call or message, or the like. Alternatively, the deliverable may include an indication that the consumer 130 should review a particular website that advantageously posts the deliverables for consumer review. Although the deliverable is disclosed with reference to various embodiments, a skilled artisan will recognize a wide number of possible deliverable formats from the disclosure herein. Moreover, according to an embodiment, the formatting module 340 sends the deliverable by forwarding it to the message delivery server 315 of the portal server system 140.

After formatting and sending the deliverable, the formatting module 340 determines, at Block 645, whether there are any more subscribers to the selected one or more request services. When there are more subscribers, the formatting process 600 proceeds to Block 630 where the formatting module 340 selects another subscriber. When there are not, the formatting process 600 proceeds to Decision Block 625 where the formatting module 340 determines whether there are more request services.

According to one embodiment, at Decision Block 635, when the changed consumer information does not meet the parameters of the subscriber, the formatting process 600 proceeds to Decision Block 645 where the formatting module 340 determines whether there are more subscribers. Thus, the formatting module 340 through the formatting process 600 advantageously accesses subscription information in order to send that consumer information corresponding to consumer-entered parameters to the consumers who subscribed to the same.

According to one embodiment, the formatting module 340 may execute the formatting process 600 in response to a wide number of events. For example, the formatting module 340 may execute the formatting process 600 when additional consumer information is added to the consumer information database 165 from a particular vendor, Internet bot, or spider, when a subscriber subscribes to one or more of the request services 550, from time to time, periodically, at a consumer-specified date or time, or the like.

Although the formatting process 600 is disclosed with reference to its preferred embodiment, the invention is not intended to be limited thereby. Rather, a skilled artisan will recognize from the disclosure herein a wide number of alternatives for formatting process 600, such as, for example, the formatting process 600 may advantageously gather all subscribed-to consumer information for a particular consumer into one deliverable to be sent to the same. Alternatively, the formatting process 600 may advantageously gather all deliverables before sending any of the same. Moreover, a skilled artisan will recognize from the disclosure herein that the formatting process 600 may include portions of some or all of the embodiments disclosed in the foregoing.

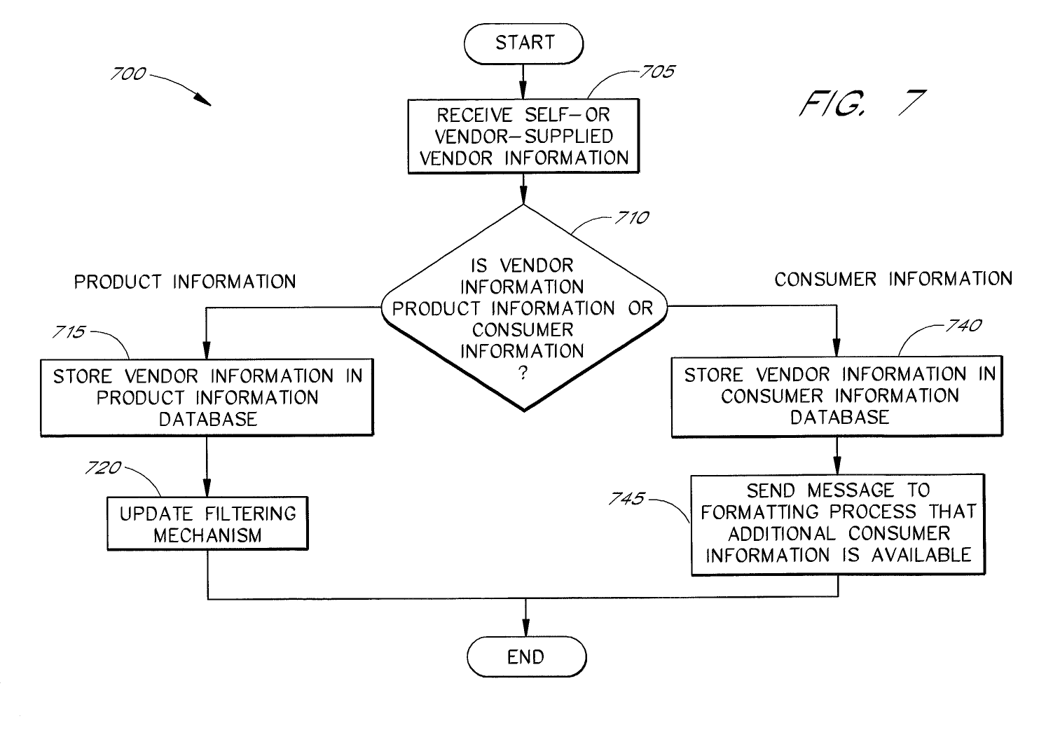

FIG. 7 illustrates a population process 700 executed by the database population module 345 of the application server 310, according to aspects of an embodiment of the system. As shown in FIG. 7, the population process 700 begins with Block 705 where the database population module 345 receives self- or vendor-supplied vendor information. According to one embodiment, self-supplied vendor information may comprise information gathered through, for example, an Internet bot or spider which accesses a wide number of websites and gains information based on criteria provided thereto. For example, a skilled artisan will recognize numerous conventional spiders or crawling software programs designed to gather information from the World Wide Web and send the information back to the originator or owner of the bots or spiders. Thus, according to one embodiment, the marketing system 120 may advantageously send Internet bots or spiders throughout the World Wide Web to collect product information and, for each product, corresponding consumer information.

Alternatively, the marketing system 120 may be operated by an entity which enters into agreements with various vendors, such that the vendors through, for example, the vendor systems 110, supply vendor information to the marketing system 120. According to one embodiment, the vendors may advantageously designate which vendor information corresponds to product information, and which corresponds to consumer information. According to another embodiment, the marketing system 120 may recognize the distinctions between the types of vendor information.

The population process 700 then proceeds to Decision Block 710 where the database population module 345 determines whether the vendor information is product information or consumer information. As mentioned in the foregoing, according to one embodiment, this determination may advantageously come from the supplier of the vendor information. When the vendor information is product information, the population process 700 proceeds to Block 715 where the database population module 345 stores the vendor information in the product information database 155. At Block 720, the database population module 345 then updates the filtering mechanisms, such as, the foregoing disclosed search constraints to reflect or account for the new product information. Moreover, according to one embodiment, the database population module 345 may advantageously update the indexes of the product information database 155, such as, for example, the indexes for “Companies,” “Brands,” or the like, in order to properly accommodate the new vendor information.

According to one embodiment, at Decision Block 710, the population process 700 may determine that the vendor information corresponds to consumer information. When the vendor information corresponds to consumer information, the population process 700 continues to Block 740, where the database population module 345 stores the vendor information in the consumer information database. For example, the database population module 345 may organize or otherwise associate the consumer information with one or more of the request services 550. The population process 700 then proceeds to Block 745 where the database population module 345 sends a message to the formatting module 340 that additional consumer information is available.

Although the foregoing invention has been described in terms of certain preferred embodiments, other embodiments will be apparent to those of ordinary skill in the art from the disclosure herein, for example, the skilled artisan will recognize a wide number of implementations of the marketing system 120, including multiple servers or other systems potentially being geographically remote from one another. Moreover, the skilled artisan will recognize from the disclosure herein that the marketing system 120 may advantageously be executed on the consumer computing device 105 interacting with, for example, one or more of the vendor systems 110.

In addition, the foregoing delivery system 100 may advantageously be adapted to provide the consumer 130 with a wide number of alternative mechanisms for filtering product information, and subscribing to the request services 550. For example, the consumer 130 may communicate through the consumer computing device 105 with the marketing system 120 and directly supply the marketing system 120 with his or her chosen product. For example, the consumer 130 may advantageously scan indicia from a product, advertisement, or the like, then use the scanned information to supply the marketing system 120 with an indication of which products the consumer 130 is interested in. According to one embodiment, the consumer 130 may use a scanning device, such as a scanning pen or scanning enabled consumer computer device, such as those commercially available from Palm, Visor, Ipaq, Clic, or the like, to scan indicia such as a bar code from a product or an advertisement.

According to one embodiment, the product may be in a retail store and the scannable indicia may be on the sales tag. According to another embodiment, the scannable indicia may be printed in a magazine, on a website, on a business card, in a book of business listings such as the Yellow Pages, or the like. Thus, according to one embodiment, the consumer 130 may advantageously designate the product for which he or she wishes to receive consumer information from, for example, bar codes, other unique or non-unique alphanumeric codes, or the like, on products, product sales tags, advertisements, print media, websites, television commercials, or the like.

According to yet another embodiment of the invention, the consumer 130 may advantageously subscribe to some or all of the request services 550 from, for example, a product listing outside the marketing system 120. For example, the vendor may advantageously provide the consumer 130 with the ability to subscribe to one or more of the request services 550 for products shown on the vendor systems 110. For example, the vendor may advantageously employ, for example, a subscription mechanism as part of a banner advertisement, or other product listing, thereby allowing the consumer 130 to subscribe to one or more of the request services 550 corresponding to the product listed in the banner. For example, the subscription mechanism may advantageously include check boxes, pull down menus, or the like.

Additionally, other combinations, admissions, substitutions, and modifications will be apparent to the skilled artisan in view of the disclosure herein. Accordingly, the present invention is not intended to be limited by the reaction of the preferred embodiment that is defined by reference to the appended claims.

What is claimed is:

1. A request based delivery system for delivering to a consumer, specific consumer information authorized by the consumer and related to one or more products or services in which the consumer is interested, the delivery system comprising:
one or more databases which store product information related to one or more products;
a communications network;
a consumer computing device which allows a consumer to connect to the communications network; and
one or more servers communicating with the one or more databases and the communications network, the one or more servers providing electronic documents over the communications network to the consumer computing device, wherein at least one server includes:
a filtering module which allows the consumer to filter the product information stored in the databases and select one or more of the products,
a subscription module which allows the consumer to subscribe to one or more request services for each of the selected one or more products,
a formatting module which, after receiving consumer information from one or more vendors of the selected one or more products, generates one or more deliverables having portions of the consumer information corresponding to the one or more request services subscribed to by the consumer.

2. The marketing system of claim 1, further comprising:
a message delivery server including an email exchange server,
wherein at least one of the one or more deliverables comprises an email, and wherein the email exchange server sends the email to the consumer.

3. The marketing system of claim 1, wherein the products include services.

4. A method of providing request-based consumer information to a consumer, the method comprising:
receiving a selection of one of the one or more filtering mechanisms designed to filter information into organized product listings;
providing a consumer with the organized product listings corresponding to the selection;
receiving a subscription from the consumer to one or more request services corresponding to one or more products listed in the organized product listings, wherein the subscription authorizes the delivery of consumer information corresponding to the one or more request services; and
delivering the consumer information to the consumer.

5. The method of claim 4, wherein the consumer information is delivered to the consumer when one or more portions of the consumer information changes.

6. The method of claim 4, wherein the organized product listings include service listings and at least one of the request services corresponds to one or more services listed in the service listings.

7. The method of claim 4, wherein at least one of the one or more filtering mechanisms comprises one of Boolean and natural language searching.

8. The method of claim 4, wherein at least one of the one or more filtering mechanisms comprises interactive browsing.

9. The method of claim 4, wherein at least one of the one or more filtering mechanisms comprises one or more search constraints.

10. The method of claim 9, wherein at least one of the one or more search constraints comprises one of “Company,” “Brand,” “Product,” and “Service.”

11. The marketing system of claim 4, wherein at least one of the one or more request services comprises one of “Discounts,” “Comparisons,” “New Releases,” “General Information,” “Catalogs,” and “Special Offers.”

12. A request based marketing system for allowing a consumer to specifically authorize consumer information to be delivered from time to time to the consumer, the marketing system comprising:
one or more databases which store consumer information organized into one or more request services, wherein the consumer information comprises information related to one or more products; and
one or more servers which format and deliver to a consumer, a deliverable having portions of the consumer information related to at least one request service of the one or more request services, the at least one request service being subscribed to by the consumer.

13. The marketing system of claim 12, wherein at least one of the one or more products comprises one or more services.

14. The marketing system of claim 12, wherein at least one of the one or more request services comprises “Discounts.”

15. The marketing system of claim 14, wherein the request service “Discounts,” comprises one of “Sales,” “Coupons,” and “Rebates.”

16. The marketing system of claim 12, wherein at least one of the one or more request services comprises “Comparisons.”

17. The marketing system of claim 16, wherein the request service “Comparisons,” comprises one of “Price,” “Policies,” and “Opinions.”

18. The marketing system of claim 12, wherein at least one of the one or more request services comprises “New Releases.”

19. The marketing system of claim 18, wherein the request service “New Releases,” comprises one of “Planned Releases,” and “Future Prototypes.”

20. The marketing system of claim 12, wherein at least one of the one or more request services comprises “General Information.”

21. The marketing system of claim 20, wherein the request service “General Information,” comprises one of “News,” “Locations,” “Support,” and “Events.”

22. The marketing system of claim 12, wherein at least one of the one or more request services comprises “Catalogs.”

23. The marketing system of claim 22, wherein the request service “Catalogs,” comprises one of “Online,” and “Mail Order.”

24. The marketing system of claim 12, wherein at least one of the one or more request services comprises “Special Offers.”

25. The marketing system of claim 24, wherein the request service “Special Offers,” comprises one of “Surveys,” “Focus Groups,” and “Samples & Feedback.”

26. The marketing system of claim 12, wherein the at least one request service being subscribed to includes one or more delivery parameters set by the consumer.

27. The marketing system of claim 26, wherein at least one of the one or more delivery parameters comprises one of frequency of delivery, delivery when the consumer information reaches a threshold, a date range, a delivery schedule, an action by a supplier of the consumer information, and an action by the consumer.

28. The marketing system of claim 12, wherein the consumer information comprises dynamic consumer information.

29. The marketing system of claim 12, wherein the deliverable comprises one of an email, a mail message, a page, a telephone call, a telephone message, a mobile phone call, a mobile phone message, and a message to a consumer computing device.

30. A method of providing consumer information about a product to a consumer interested in the product, the method comprising:
receiving a selection of a product by a consumer;
organizing consumer information about the product into specific subject areas;
receiving a selection of one or more of the specific subject areas; and
formatting a deliverable to be sent to the consumer, the deliverable including portions of the consumer information corresponding to the selected one or more specific subject areas.

31. The method of claim 30, wherein the product comprises a service.

32. The method of claim 30, wherein the receiving the selection of the product comprises receiving search constraints including one of “Company,” “Brand,”“Product,” and “Service.”

33. The method of claim 30, wherein the receiving the selection of the product comprises receiving searching criteria and returning search results.

34. The method of claim 30, wherein the receiving the selection of the product comprises receiving selections of topical and subtopical information.

35. The method of claim 30, wherein the receiving the selection of the product comprises receiving information acquired by the consumer using a consumer computing device capable of reading barcodes.

36. The method of claim 35, wherein the personal computing device comprises one of a personal digital assistant and a mobile phone.

37. The method of claim 30, wherein the consumer information includes dynamic consumer information.

38. The method of claim 30, wherein at least one of the specific subject areas comprises consumer-specified parameters, wherein at least one of the consumer-specified parameters comprises one of a frequency of delivery, a delivery schedule, a delivery when the consumer information reaches a threshold, a delivery date range, an action by a supplier of the consumer information, and an action by the consumer.

39. The method of claim 30, wherein at least one of the specific subject areas comprises one of “Discounts,” “Comparisons,” “New Releases,” “General Information,” “Catalogs,” and “Special Offers.”

40. The method of claim 30, wherein at least one of the specific subject areas comprises one or more request services.

41. The method of claim 30, wherein the deliverable includes one of an email, a mail message, a page, a telephone call, a telephone message, a mobile phone call, a mobile phone message, and a message to a consumer computing device.

42. The method of claim 30, wherein the deliverable allows the consumer to purchase the product.

43. The method of claim 30, wherein the deliverable allows the consumer to access online information from a vendor of the product.

44. The method of claim 30, wherein the deliverable allows the consumer to access additional online information.

45. The method of claim 30, wherein the deliverable allows the consumer to select more of the one or more specific subject areas.

46. A method of organizing online product information from multiple vendors in order for a consumer to efficiently request specific information corresponding to a particular product, the method comprising:
gathering product listings from multiple vendors;
organizing the product listings by brand; and
providing a consumer with an option to request additional information about at least one product in the product listings marketed under at least one brand.

47. The method of claim 46, further comprising providing the consumer with the additional information.

48. The method of claim 46, wherein at least some of the product listings comprise service listings and the consumer may request the additional information about at least one service in the service listings.

49. The method of claim 46, wherein the option to request the additional information includes providing the consumer with the option to subscribe to one or more request services.

50. The method of claim 49, wherein at least one of the one or more request services comprises one of “Discounts,” “Comparisons,” “New Releases,” “General Information,” “Catalogs,” and “Special Offers.”

51. A method of organizing online product information from multiple vendors in order for a consumer to efficiently request specific information corresponding to a particular product, the method comprising:
gathering product listings from multiple vendors;
organizing the product listings by company; and
providing a consumer with an option to request additional information about at least one product in the product listings marketed by at least one company.

52. A method of organizing online product information from multiple vendors in order for a consumer to efficiently request specific information corresponding to a particular product, the method comprising:
gathering product listings from multiple vendors;
organizing the product listings by product; and
providing a consumer with an option to request additional information about at least one product in the product listings.

53. A method of placing advertisement information for one or more products with consumers directly interested in the one or more products, the method comprising providing advertisement information for a product to an online company, the advertisement information including a listing of the product and consumer information about the product, wherein the online company obtains subscribers to one or more request services and delivers that portion of the consumer information to the subscriber corresponding to the one or more request services to which the subscriber subscribed.

54. The method of claim 53, wherein at least one of the one or more products comprises a service.

55. A method of obtaining information about a product, the method comprising:
accessing an online service;
selecting a product from product listings of the online service;
subscribing to one or more subject areas of consumer information about the selected product;
designating delivery parameters corresponding to the subscription, wherein the delivery parameters govern when the consumer information corresponding to the subscribed-to subject areas will be delivered; and
receiving the consumer information corresponding to the subscription.

56. The method of claim 55, wherein the product comprises a service.

57. The method of claim 55, wherein the delivery parameters govern how the consumer information will be delivered.

58. The method of claim 55, wherein the delivery parameters govern the portions of the consumer information to be delivered.
